(19) United States
(12) Patent Application Publication
(10) Pub. No.: US 2023/0274143 A1
(43) Pub. Date: Aug. 31, 2023

(54) Complementary Prompting For Rehearsal-Free Continual Learning

(71) Applicant: Google LLC, Mountain View, CA (US)

(72) Inventors: Zizhao Zhang, San Jose, CA (US); Zifeng Wang, Mountain View, CA (US); Chen-Yu Lee, Mountain View, CA (US); Ruoxi Sun, Mountain View, CA (US); Sayna Ebrahimi, Los Altos Hills, CA (US); Xiaoqi Ren, Bothell, WA (US); Guolong Su, State College, PA (US); Vincent Perot, Brooklyn, NY (US); Tomas Pfister, Foster City, CA (US); Han Zhang, Sunnyvale, CA (US)

(73) Assignee: Google LLC, Mountain View, CA (US)

(21) Appl. No.: 18/173,985

(22) Filed: Feb. 24, 2023

Related U.S. Application Data
(60) Provisional application No. 63/268,639, filed on Feb. 28, 2022.

(51) Int. Cl. G06N 3/08

(52) U.S. Cl. CPC G06N 3/08

(57) ABSTRACT

A method for rehearsal-free continual learning includes obtaining a set of training samples where training sample in the set of training samples is associated with a respective task of a plurality of different tasks. The method includes obtaining a task-invariant prompt representative of learned knowledge common to each respective task of the plurality of different tasks. The method includes, for each respective task of the plurality of different tasks, obtaining a respective task-specific prompt representative of learned knowledge specific to the respective task. The method includes, during each of one or more training iterations, for each respective training sample in the set of training samples, selecting the respective task-specific prompt representative of the respective task of the respective training sample and training a model using the task-invariant prompt and the selected respective task-specific prompt.

### CROSS REFERENCE TO RELATED APPLICATIONS

This U.S. patent application claims priority under 35 U.S.C. § 119(e) to U.S. Provisional Application 63/268,639, filed on Feb. 28, 2022. The disclosure of this prior application is considered part of the disclosure of this application and is hereby incorporated by reference in its entirety.

### TECHNICAL FIELD

This disclosure relates to complementary prompting for rehearsal-free continual learning.

### BACKGROUND

Continual learning aims at enabling a single model to learn a sequence of tasks without catastrophic forgetting (i.e., catastrophic interference). It remains a very challenging problem even when applying powerful deep learning models on a simple dataset. Most existing methods require a rehearsal buffer to store past data for experience replay, which, however, may not be available in real world scenarios due to privacy and/or memory constraints.

### SUMMARY

One aspect of the disclosure provides a method for complementary prompting for rehearsal-free continual learning. The computer-implemented method, when executed by data processing hardware, causes the data processing hardware to perform operations. The operations include obtaining a set of training samples. Each training sample in the set of training samples is associated with a respective task of a plurality of different tasks. The operations include obtaining a task-invariant prompt representative of learned knowledge common to each respective task of the plurality of different tasks. For each respective task of the plurality of different tasks, the operations include obtaining a respective task-specific prompt representative of learned knowledge specific to the respective task. During each of one or more training iterations, for each respective training sample in the set of training samples, the operations include selecting the respective task-specific prompt representative of the respective task of the respective training sample and training a model using the task-invariant prompt and the selected respective task-specific prompt.

Implementations of the disclosure may include one or more of the following optional features. In some implementations, each respective training sample includes an image. In some examples, training the model includes updating a pre-trained model with the task-invariant prompt and the selected respective task-specific prompt. In some of these examples, updating the pre-trained model with the task-invariant prompt and the selected respective task-specific prompt includes inserting the task-invariant prompt at a first layer of the pre-trained model and inserting the respective task-specific prompt at a second layer of the pre-trained model. Optionally, the first layer and the second layer are each a self-attention layer. Inserting the task-invariant prompt at the first layer of the pre-trained model may include prepending the task-invariant prompt to an input embedding feature of the first layer. Inserting the respective task-specific prompt at the second layer of the pre-trained model may include prepending the respective task-specific prompt to an input embedding feature of the second layer.

In some implementations, each respective task-specific prompt is associated with task-specific key representative of one or more features of the respective task. In some examples, training the model using the task-invariant prompt and the selected respective task-specific prompt includes determining a cross-entropy loss. Each respective task of the plurality of different tasks may include image classification.

Another aspect of the disclosure provides a system for complementary prompting for rehearsal-free continual learning. The system includes data processing hardware and memory hardware in communication with the data processing hardware. The memory hardware stores instructions that when executed on the data processing hardware cause the data processing hardware to perform operations. The operations include obtaining a set of training samples. Each training sample in the set of training samples is associated with a respective task of a plurality of different tasks. The operations include obtaining a task-invariant prompt representative of learned knowledge common to each respective task of the plurality of different tasks. For each respective task of the plurality of different tasks, the operations include obtaining a respective task-specific prompt representative of learned knowledge specific to the respective task. During each of one or more training iterations, for each respective training sample in the set of training samples, the operations include selecting the respective task-specific prompt representative of the respective task of the respective training sample and training a model using the task-invariant prompt and the selected respective task-specific prompt.

This aspect may include one or more of the following optional features. In some implementations, each respective training sample includes an image. In some examples, training the model includes updating a pre-trained model with the task-invariant prompt and the selected respective task-specific prompt. In some of these examples, updating the pre-trained model with the task-invariant prompt and the selected respective task-specific prompt includes inserting the task-invariant prompt at a first layer of the pre-trained model and inserting the respective task-specific prompt at a second layer of the pre-trained model. Optionally, the first layer and the second layer are each a self-attention layer. Inserting the task-invariant prompt at the first layer of the pre-trained model may include prepending the task-invariant prompt to an input embedding feature of the first layer. Inserting the respective task-specific prompt at the second layer of the pre-trained model may include prepending the respective task-specific prompt to an input embedding feature of the second layer.

In some implementations, each respective task-specific prompt is associated with task-specific key representative of one or more features of the respective task. In some examples, training the model using the task-invariant prompt and the selected respective task-specific prompt includes determining a cross-entropy loss. Each respective task of the plurality of different tasks may include image classification.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for complementary prompting for rehearsal-free continual learning.

FIGS. 2A and 2B are schematic views of exemplary components of the system of FIG. 1.

FIGS. 3A and 3B are schematic views of exemplary algorithms implemented by the system of FIG. 1.

FIG. 4 a flowchart of an example arrangement of operations for a method of for complementary prompting for rehearsal-free continual learning.

FIG. 5 is a schematic view of an example computing device that may be used to implement the systems and methods described herein.

Like reference symbols in the various drawings indicate like elements.

### DETAILED DESCRIPTION

A central goal of continual learning (CL) is to learn a sequence of tasks with a single model without suffering from catastrophic forgetting (i.e., a significant deterioration in performance on previously seen data). Some existing methods aim at preserving and extending the acquired knowledge during the continual learning process. Architecture-based methods may assign isolated parameters to encode learned knowledge from different tasks. However, these methods often introduce a substantial number of additional parameters and sometimes involve simplified assumption such as known test time task identity, which falls into the setting of task-incremental learning. The task-incremental setting is often considered over-simplified, because task identity is not known at test time in practical applications. Other methods include rehearsal-based CL methods, which preserve past knowledge directly by keeping data from prior tasks in a rehearsal buffer. Due to their conceptual simplicity, generalizability to various settings, and superior ability to mitigate catastrophic forgetting, rehearsal-based methods have been widely recognized as the reigning state-of-the-art in the challenging class-incremental setting. Critically, these methods cannot be used in applications with privacy concerns or when memory budget is highly constrained. Thus, it is desirable to develop a parsimonious, rehearsal-free continual learning method that can achieve similar or higher level of performance.

A more modern technique, Learning to Prompt (L2P), approaches this problem from a brand-new perspective. That is, L2P proposes to leverage learnable prompt parameters to encode knowledge in a more succinct way (i.e., a prompt pool) than buffer, thus implementing a rehearsal buffer is no longer necessary. Prompt techniques were originally introduced in natural language processing (NLP) for task adaptation of large-scale pre-trained models by attaching fixed or learnable “instructions,” because prompts are designed to instruct the model to properly reuse learned representations instead of learning new representations from scratch. The L2P technique successfully formulates the problem of learning new tasks as training small prompt parameters attached to a pre-trained frozen model. However, the performance of modern L2P techniques is still lower than rehearsal-based methods.

In L2P, one single prompt pool is designed to transfer knowledge from one task to another without distinguishing between the common features among all tasks versus the features that are unique to each task. Such a design may be sub-optimal from the perspective of theory of Complementary Learning Systems (CLS), an intuition that many recent advanced CL methods are based on. The theory of CLS suggests that humans learn continually via the synergy between two learning systems: the hippocampus focuses on learning pattern-separated representation on specific experiences, and the neocortex focuses on learning more general and transferable representation from past experience sequences. Thus, they are able to learn task-specific knowledge separately without interference while leveraging task-invariant knowledge to have greater learning capacity to learn future tasks better. However, previous CLS-driven methods still decouple or expand the backbone parameters to learn the two kinds of knowledge. Thus, these methods still rely on constructing a rehearsal buffer repeatedly to consolidate decoupled knowledge to prevent catastrophic forgetting.

Implementations herein include a rehearsal-free model that encodes learned knowledge from sequential tasks in small learnable parameters called prompts, given a pre-trained model. The model explicitly decouples prompt parameters into a task-invariant prompt (i.e., a general-prompt or G-Prompt) for learning task-invariant knowledge and a task-specific prompt (i.e., an expert-prompt or E-Prompt) for learning task-specific knowledge. This provides a simple yet novel and effective framework that largely improves the continual learning practicality without data or memory access concerns. The model outperforms rehearsal-based methods even with relatively large buffer size.

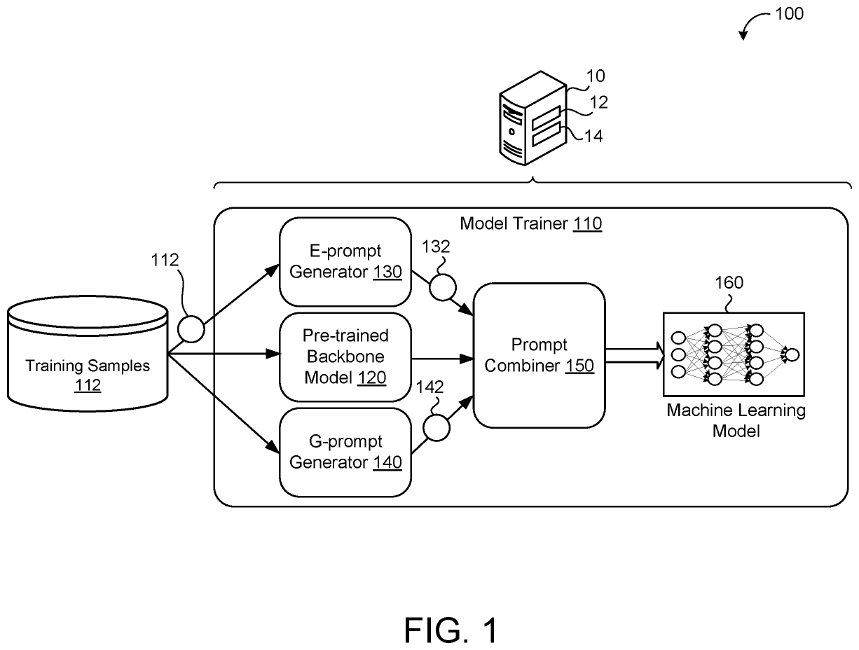

Referring to FIG. 1, in some implementations, an example system 100 includes a processing system 10. The processing system 10 may be a single computer, multiple computers, or a distributed system (e.g., a cloud environment) having fixed or scalable/elastic computing resources 12 (e.g., data processing hardware) and/or storage resources 14 (e.g., memory hardware). The processing system 10 executes a model trainer 110. The model trainer 110 trains a target model 160 (e.g., a deep neural network (DNN)) to make predictions based on input data. For example, the model trainer 110 trains a convolutional neural network (CNN). The model trainer 110 trains the target model 160 on a set of training samples 112. Each training sample may include an image. The target model 160 is trained to perform a sequence of different tasks. The tasks may include image classification.

The model trainer 110 may include a pre-trained backbone model 120. The backbone model 120 may be a sequence model such as a vision transformer model. The model trainer 110, in some implementations, includes an E-prompt generator 130 (i.e., an expert prompt generator) that obtains or generates, for each task of the different tasks, a task-specific prompt 132 (also referred to herein as an E-prompt 132) that represents learned knowledge specific to only the respective task (and not general to the other tasks). The model trainer 110 also includes a G-prompt generator 140 (i.e., a general prompt generator) that obtains or generates a task-invariant prompt 142 (also referred to herein as a G-prompt 142) that represents learned knowledge common to each task of the different tasks. That is, each task-specific prompt 132 represents learned knowledge for a single task while the task-invariant prompt 142 represents knowledge common or applicable to each of the tasks.

The model trainer 110 includes a prompt combiner 150 that combines the task-specific prompts 132, the task-invariant prompt 142, and the pre-trained model 120 into the machine learning model 160. Thus, the two types of prompts 132, 142 encode respective knowledge during training with the backbone model 120 and instruct the machine learning model 160 to make task-specific predictions at inference. The prompts 132, 142 are trainable parameters attached to the backbone model 120. For example, the prompts 132, 142 are inserted into one or more self-attention/multi-stage aggregation (MSA) layers of the backbone model 120. In some examples, the model trainer 110 updates the pre-trained model 120 by inserting the task-invariant prompt 142 at a first layer (e.g., a self-attention layer) of the pre-trained model and/or by inserting the respective task-specific prompt 132 at a second layer (e.g., a self-attention layer) of the pre-trained model 120. As discussed in more detail below, in some implementations, inserting the task-invariant prompt 142 at the first layer of the pre-trained model 120 includes prepending the task-invariant prompt 142 to an input embedding feature of the first layer and/or inserting the respective task-specific prompt 132 at the second layer of the pre-trained model includes prepending the respective task-specific prompt 132 to an input embedding feature of the second layer. The G-prompt 142 and the E-Prompt 132 may be attached/inserted at any layer of the pre-trained model 120. For example, the E-Prompt 132 may be inserted at only a single layer (e.g., the fifth MSA layer) or at multiple layers (e.g., the third through the fifth MSA layers). The layers may be selected based on the pre-trained model and/or the training samples 112 and the corresponding performance of the model 160.

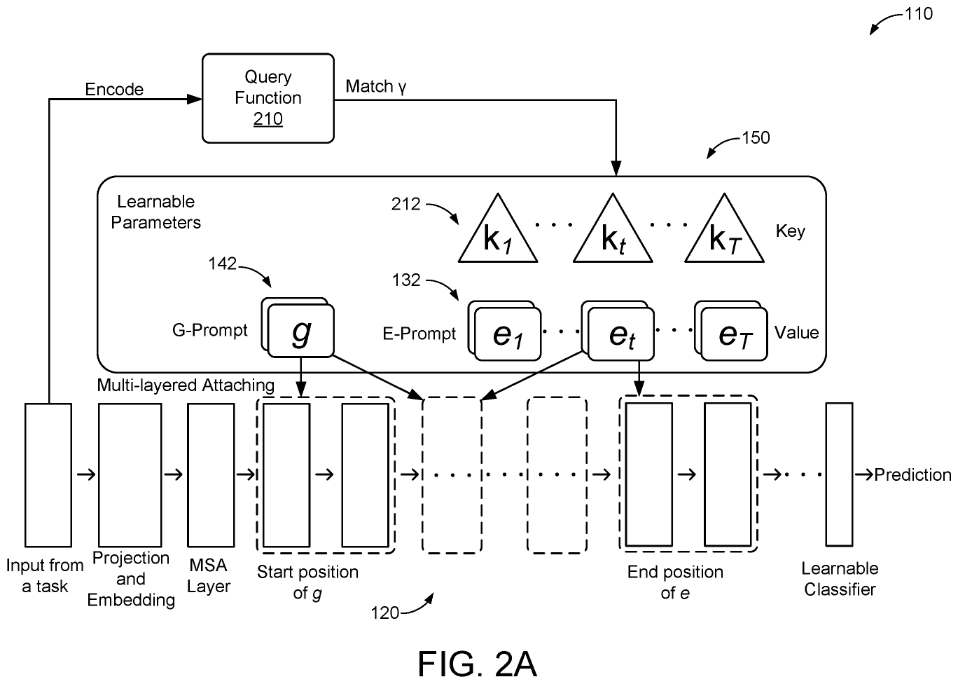

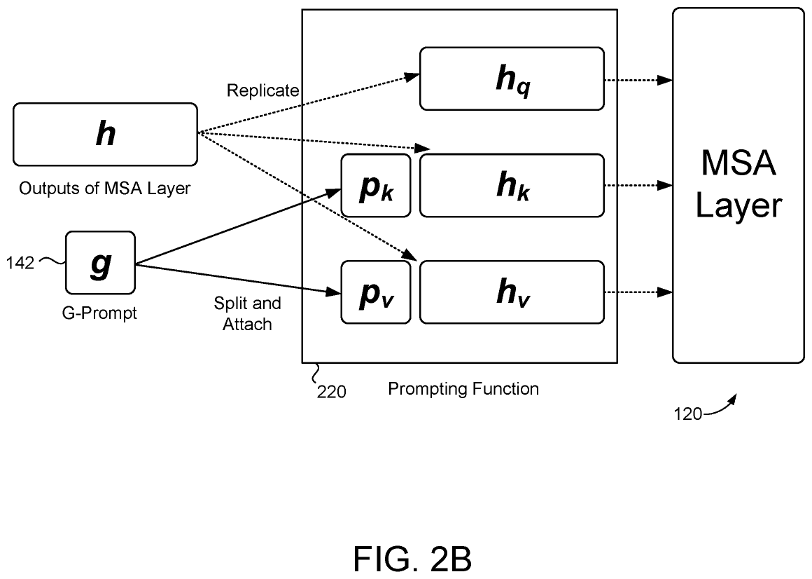

Referring now to FIG. 2A, in some implementations, each task-specific prompt 132 may be associated with a task-specific key 212 representative of one or more features of the respective task. At test time (i.e., during inference), an input may be transformed by a query function 210 to match the closest task key 212 (10 and the corresponding E-Prompt 132 (eₜ). Next, the prompt combiner 150 may attach the shared G-Prompt 142 (g) and the matched E-Prompt 132 eₜ to multiple MSA layers of the pre-trained model 120 or transformer. At training time, the E-Prompt 132 is selected by task identity and the selected E-Prompt 132 and G-Prompt 142 are trained together with a classifier.

Referring now to FIG. 2B, in some implementations, the model trainer 110 splits the G-Prompt 142 equally and attaches the split G-Prompt 142 to the key and value replicas of a hidden feature in a prompting function before passing them to the MSA layer. Given a pre-trained vision transformer ƒ with N consecutive MSA layers, the input embedding feature of the i-th MSA layer may be denoted as h⁽ⁱ⁾, i=1, 2, . . . , N. The G-Prompt 142 may be represented as gϵ [symbol] ^{Lg×D} with sequence length L_{g} and embedding dimension D as a shared parameter for all tasks. To attach the G-Prompt 142 to the i-th MSA layer, the G-Prompt 142 transforms h⁽ⁱ⁾ via a prompting function 220:

h_{g}⁽ⁱ⁾=ƒₚᵣₒₘₚₜ(g,h⁽ⁱ⁾) (1)

Here, ƒₚᵣₒₘₚₜ defines how to attach the prompts to the hidden embeddings, as discussed in more detail below.

The E-Prompt 132 may be represented as E={eₜ}ₜ₌₁^{T} as a set of task-dependent parameters, where eₜϵ [symbol] ^{Lg×D} has a sequence length of Lₑ and the same embedding dimension D as the G-Prompt 142, and T is the total number of tasks. In contrast from the shared G-Prompt 142, each eₜ is associated with a task-specific key kₜϵ [symbol] ^{D}, which is also a learnable parameter that aims to capture representative features of a task. For an input example from the t-th task, to attach an E-Prompt 132 to the j-th MSA layer, the model trainer 110 may apply the prompting function in a similar way:

hₑ⁽ⁱ⁾=ƒₚᵣₒₘₚₜ(e^{t},h^{(j)}) (2)

Referring back to FIG. 2A, the model trainer 110, in some examples, updates the pre-trained model 120 with the task-invariant prompt 142 and the respective task-specific prompt 132. That is, the model trainer 110 may update the corresponding kₜ to match the feature of the input instance via a matching loss [symbol] _{match}, such that kₜ becomes “closer” to examples from the t-th task than other keys. At inference, the model trainer 110 may implement a query function q on the test sample to search for the best match from the task keys and select the corresponding E-Prompt 132 to use. The model trainer 110 may directly use the entire pre-trained model 120 as the query function q(x)=ƒ(x) with cosine similarity as γ. Thus, the matching loss takes the following form:

[symbol]

_{match}(x,kₜ)=γ(q(x),kₜ),xϵDₜ (3)

G-prompts 142 and E-prompts 132 encode respective type of instructions during training with the backbone model 120 and cooperatively instruct the target model 160 to make predictions at inference. Conventional prompt-related work simply places prompts only at a first MSA layer or at every MSA layer. Intuitively, different layers of the backbone model 120 have different levels of feature abstraction. Therefore, when learning tasks sequentially, some layers of representations can have higher responses to task-specific knowledge than others, and vice versa for task-invariant knowledge. Thus, implementations herein provide the two types of prompts more flexibility to attach to the most proper positions in a decoupled way, thus different instructions can interact with the corresponding representations more effectively.

A multi-layered extension of both types of prompts may be represented by:

$$g = {\{ {g}^{( l )} \}}_{l = {start}_{g}}^{e n {d}_{g}} ,$$

where g^{(l)}ϵ [symbol] ^{Lg×D} is the G-Prompt 142 to be attached to the l-th MSA layer. The E-Prompt

$${e}_{t} = {\{ {e}_{t}^{( l )} \}}_{l = {start}_{e}}^{{end}_{e}}$$

may be defined similarly. In this way, the G-Prompt 142 g^{(l)} may be attached from the start_{g}-th to the end_{g}-th MSA layers, and attach the E-Prompt eₜ^{(l)} from the startₑ-th to the endₑ-th MSA layers. And most importantly, (start_{g}, end_{g}) and (startₑ, endₑ) may be totally different or non-overlapping. Note that it may be assumed that the chosen indices of MSA layers to attach prompts are contiguous. However, other more advanced ways to auto-search the configuration may be used.

The prompting function ƒₚᵣₒₘₚₜ controls the way the model trainer 110 combines prompts with the embedding features. From another perspective, ƒₚᵣₒₘₚₜ directly affects how the high-level instructions in prompts interact with low-level representations. Thus, a well-designed prompting function is vital for the overall continual learning performance. The model trainer 110 may implement any number of various prompting functions (e.g., Prompt Tuning (Pro-T) and/or Prefix Tuning (Pre-T)). Specifically, applying a prompting function may be viewed as modifying the inputs of the MSA layers. For example, when the input to the MSA layer is hϵ [symbol] ^{L×D} and the input query, key, and values for the MSA layer are defined by h_{Q}, h_{K}, and h_{V}, respectively. The MSA layer is proposed by:

MSA(h_{Q},h_{K},h_{V})=Concat(h₁, . . . ,hₘ)W^{O} where

hᵢ=Attention(h_{Q}Wᵢ^{Q},hWᵢ^{K},h_{V}Wᵢ^{V})

Here, where W^{O}, Wᵢ^{Q}, Wᵢ^{K}, and Wᵢ^{V} are projection matrices. The variable m represents the number of heads. In a vision transformer, h_{Q}=h_{K}=h_{V}. A unified prompt parameter may be defined as pϵ [symbol] ^{Lp×D} (where p could be either a single-layered G-Prompt 142 or E-Prompt).

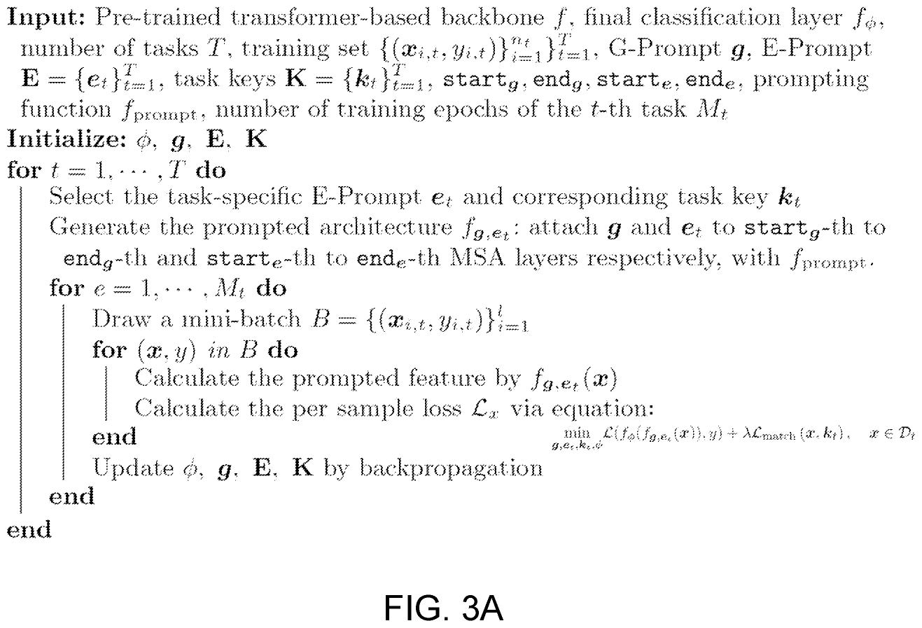

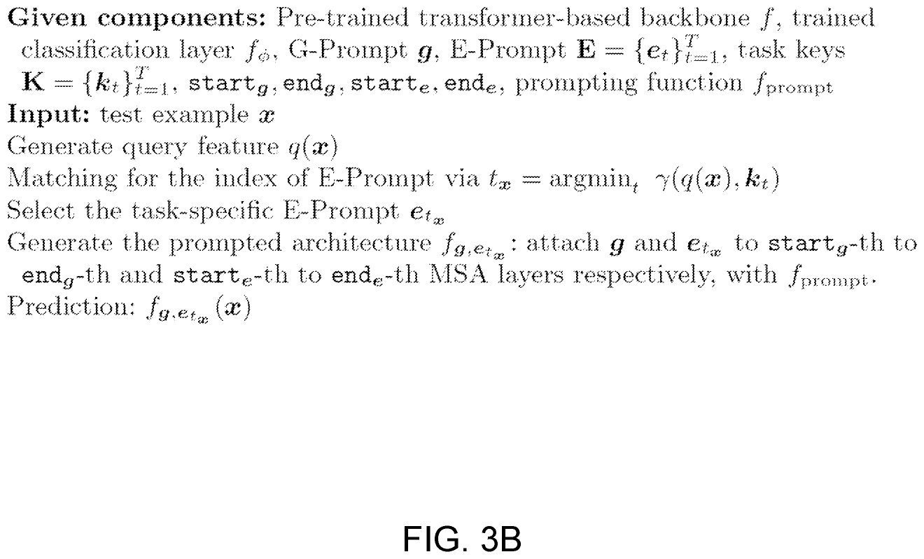

FIGS. 3A and 3B illustrate an exemplary training time algorithm for the model trainer 110 and an exemplary test time or inference time algorithm for the model trainer 110 respectively. In this example, the architecture is denoted with prompts attached by ƒ_{g}, eₜ. Next, the input x is transformed from the t-th task via ƒ_{g}, eₜ and sent to a classification head ƒ_{φ} parameterized by φ for prediction. Next, both types of prompts are trained with the task keys and newly-initialized classification head in an end-to-end fashion:

min_{g,e}_{ₜ}_{,k}_{ₜ}_{,φ} [symbol] (ƒ_{φ}(ƒ_{g,e}_{ₜ},(x)),y)+λ [symbol] _{match}(x,kₜ),xϵDₜ (4)

Here, [symbol] is the cross-entropy loss, [symbol] _{match} is defined by Equation (3), and λ is a scalar balancing factor. That is, in some examples, training the model 160 includes determining the cross-entropy loss [symbol] _{match}.

Thus, implementations herein include a model trainer 110 that achieves rehearsal-free continual learning under the challenging class-incremental setting. The model trainer 110 attaches complementary prompts to a pre-trained model 120 to learn decoupled knowledge. Because large-scale pre-trained models are widely used in practice for their great representation power, the model trainer 110 may serve as a starting point for real-world rehearsal-free continual learning systems.

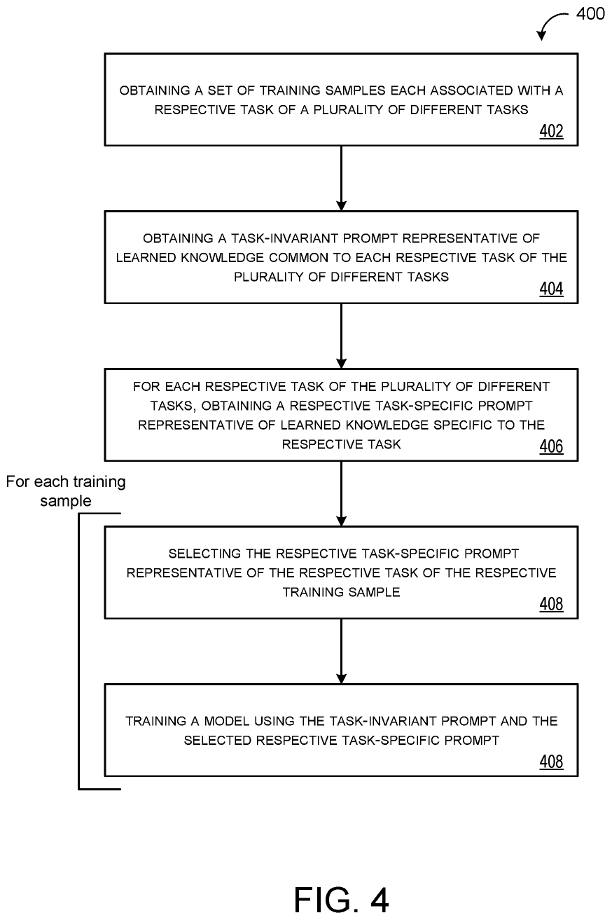

FIG. 4 is a flowchart of an exemplary arrangement of operations for a method 400 for complementary prompting for rehearsal-free continual learning. The method 400, at operation 402, includes obtaining a set of training samples 112. Each training sample 112 in the set of training samples 112 is associated with a respective task of a plurality of different tasks. The method 400, at operation 404, includes obtaining a task-invariant prompt 142 representative of learned knowledge common to each respective task of the plurality of different tasks. The method 400, at operation 406, for each respective task of the plurality of different tasks, includes obtaining a respective task-specific prompt 132 representative of learned knowledge specific to the respective task. During each of one or more training iterations, for each respective training sample 112 in the set of training samples 112, the method 400, at operation 408 includes selecting the respective task-specific prompt 132 representative of the respective task of the respective training sample 112 and, at operation 410, training a model 160 using the task-invariant prompt 142 and the selected respective task-specific prompt 132.

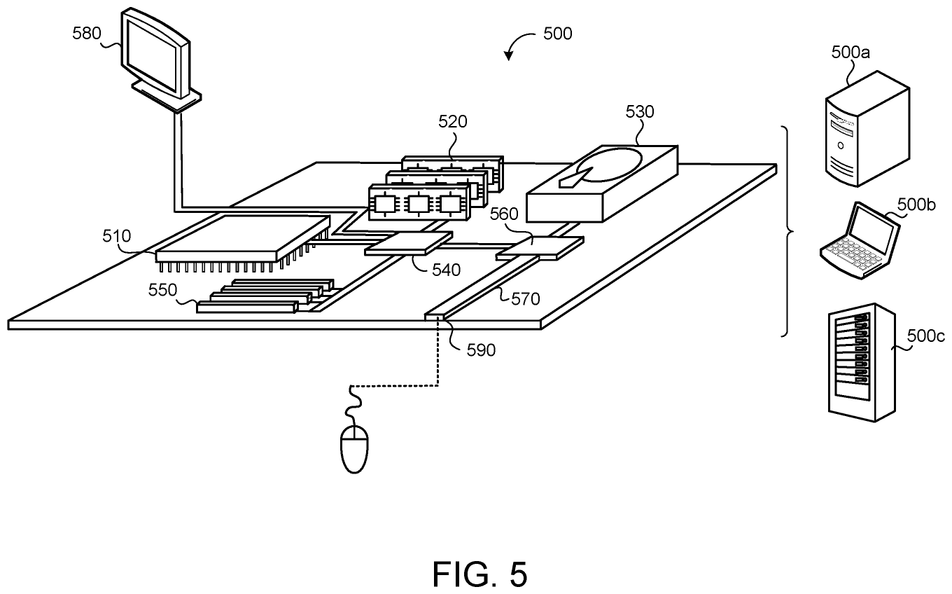

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed by data processing hardware causes the data processing hardware to perform operations comprising:
obtaining a set of training samples, each training sample in the set of training samples associated with a respective task of a plurality of different tasks;
obtaining a task-invariant prompt representative of learned knowledge common to each respective task of the plurality of different tasks;
for each respective task of the plurality of different tasks, obtaining a respective task-specific prompt representative of learned knowledge specific to the respective task; and
during each of one or more training iterations, for each respective training sample in the set of training samples:
selecting the respective task-specific prompt representative of the respective task of the respective training sample; and
training a model using the task-invariant prompt and the selected respective task-specific prompt.

2. The method of claim 1, wherein each respective training sample comprises an image.

3. The method of claim 1, wherein training the model comprises updating a pre-trained model with the task-invariant prompt and the selected respective task-specific prompt.

4. The method of claim 3, wherein updating the pre-trained model with the task-invariant prompt and the selected respective task-specific prompt comprises:
inserting the task-invariant prompt at a first layer of the pre-trained model; and
inserting the respective task-specific prompt at a second layer of the pre-trained model.

5. The method of claim 4, wherein the first layer and the second layer are each a self-attention layer.

6. The method of claim 4, wherein inserting the task-invariant prompt at the first layer of the pre-trained model comprises prepending the task-invariant prompt to an input embedding feature of the first layer.

7. The method of claim 4, wherein inserting the respective task-specific prompt at the second layer of the pre-trained model comprises prepending the respective task-specific prompt to an input embedding feature of the second layer.

8. The method of claim 1, wherein each respective task-specific prompt is associated with task-specific key representative of one or more features of the respective task.

9. The method of claim 1, wherein training the model using the task-invariant prompt and the selected respective task-specific prompt comprises determining a cross-entropy loss.

10. The method of claim 1, wherein each respective task of the plurality of different tasks comprises image classification.

11. A system comprising:
data processing hardware; and
memory hardware in communication with the data processing hardware, the memory hardware storing instructions that when executed on the data processing hardware cause the data processing hardware to perform operations comprising:
obtaining a set of training samples, each training sample in the set of training samples associated with a respective task of a plurality of different tasks;
obtaining a task-invariant prompt representative of learned knowledge common to each respective task of the plurality of different tasks;
for each respective task of the plurality of different tasks, obtaining a respective task-specific prompt representative of learned knowledge specific to the respective task; and
during each of one or more training iterations, for each respective training sample in the set of training samples:
selecting the respective task-specific prompt representative of the respective task of the respective training sample; and
training a model using the task-invariant prompt and the selected respective task-specific prompt.

12. The system of claim 11, wherein each respective training sample comprises an image.

13. The system of claim 11, wherein training the model comprises updating a pre-trained model with the task-invariant prompt and the selected respective task-specific prompt.

14. The system of claim 13, wherein updating the pre-trained model with the task-invariant prompt and the selected respective task-specific prompt comprises:
inserting the task-invariant prompt at a first layer of the pre-trained model; and
inserting the respective task-specific prompt at a second layer of the pre-trained model.

15. The system of claim 14, wherein the first layer and the second layer are each a self-attention layer.

16. The system of claim 14, wherein inserting the task-invariant prompt at the first layer of the pre-trained model comprises prepending the task-invariant prompt to an input embedding feature of the first layer.

17. The system of claim 14, wherein inserting the respective task-specific prompt at the second layer of the pre-trained model comprises prepending the respective task-specific prompt to an input embedding feature of the second layer.

18. The system of claim 11, wherein each respective task-specific prompt is associated with task-specific key representative of one or more features of the respective task.

19. The system of claim 11, wherein training the model using the task-invariant prompt and the selected respective task-specific prompt comprises determining a cross-entropy loss.

20. The system of claim 11, wherein each respective task of the plurality of different tasks comprises image classification.
